(19) United States
(12) Patent Application Publication
(10) Pub. No.: US 2014/0374032 A1
(43) Pub. Date: Dec. 25, 2014

(54) ELECTRICALLY DIVISIBLE POLYAMIDE ADHESIVE

(71) Applicants: Henkel AG & Co. KGaA, Duesseldorf (DE); Fraunhofer Gesellschaft zur Förderung der angewandten Forschung e.V., Munchen (DE)

(72) Inventors: Reimar Heucher, Pulheim (DE); Siegfried Kopannia, Krefeld (DE); Ciaran McArdle, Dublin (IE); Manuela Stuve, Dourverden (DE); Jana Kolbe, Bremen (DE)

(21) Appl. No.: 14/484,451

(22) Filed: Sep. 12, 2014

Related U.S. Application Data
(63) Continuation of application No. PCT/EP2013/054972, filed on Mar. 12, 2013.

(30) Foreign Application Priority Data
Mar. 12, 2012 (DE) 102012203794.2

(51) Int. Cl. C09J 177/06; B32B 7/06; B32B 43/00; B32B 7/12

(52) U.S. Cl. CPC C09J 177/06; B32B 7/12; B32B 7/06; B32B 43/006; C09J 2477/00; B32B 2250/02; B32B 2255/26; B32B 2307/202; B32B 2377/00; B32B 2405/00; B32B 2310/021
USPC 156/752; 524/168; 428/474.4

(57) ABSTRACT

A melt adhesive containing 20 to 90 wt % of at least one polyamide having a molecular weight (Mw) from 10,000 to 250,000 g/mol; 1 to 25 wt % of at least one organic or inorganic salt; 0 to 60 wt % of further additives, wherein the adhesive has a softening point from 100° C. to 220° C. Additionally described is a process for reversible adhesive bonding of substrates, wherein the adhesive bond is released under tension after application of an electrical voltage.

The invention relates to a holt melt adhesive based on polyamides which, as a layer, decreases its adhesive strength under the influence of voltage. The invention further relates to an adhesive that is constructed from polyamides and contains ionically conductive constituents.

Adhesives that contain ionic liquids are known, as well as various ionic liquids that can generate a conductivity in solids.

U.S. 2004/0097755 describes an ionic composition that is capable of forming hydrogen bonds. The composition is said to have a melting point of up to 100° C., and to contain a quaternary amine salt. The proportion of the amine salt and the organic component should be between 1:1.5 and 1:2.5.

U.S. Pat. No. 7,183,433 describes ionic compositions having a solidification point of up to 100° C. Quaternary or neutralized amines are also described as a salt; low-molecular-weight substances such as ureas, esters, ketones, phenols, or amides are described as an organic component.

WO 2008/150227 claims an electrically softenable adhesive composition that is said to have an adhesive strength, said adhesive strength being decreased upon application of voltage. This composition is said, however, to have ionically conductive properties. The composition is said in particular to contain particles and fibers that form ionically conductive channels. While further statements are made regarding the nature and composition of the ionically conductive particles, the description is without further specifications as to the corresponding binding agents.

WO 2001/05584 and U.S. 2008/0283415 A1 describe adhesives that are made of various polymers and ionically conductive substances. These are one- or two-component reactive adhesives based on acrylates and/or epoxies. The adhesive strength is established by reaction of the acrylate groups or epoxy groups.

The compositions according to the state of the art are in part less suitable for being used as holt melt adhesives. If no polymeric base components are used, the melting point or solidification point is relatively low, so that even usual ambient temperature does not ensure firm adhesion. The use of substances that form ionically conductive channels restricts the possible compositions. The polymers in the adhesives must meet the requirements for hot melt adhesives in terms of their properties. It is furthermore useful to select those constituents which demand only minor limitations in terms of occupational safety.

The object of the invention is therefore to provide a hot melt adhesive that, as a hot melt adhesive, exhibits the properties necessary for hot melt application. This adhesive is furthermore intended to contain an ionic substance that is miscible in stable fashion and has little influence on the melting point for a corresponding use. The composition is furthermore intended to bring about a good adhesive bond when applied as an adhesive layer between two substrates. Upon application of voltage transversely through the adhesive layer, the adhesive bond is to be weakened so that release of the substrates from one another is possible.

The object is achieved by a melt adhesive containing: −20 to 90 wt % of at least one polyamide having a molecular weight (Mw) from 10,000 to 250,000 g/mol; −1 to 25 wt % of at least one organic or inorganic salt; −0 to 60 wt % of further additives, wherein the adhesive has a softening point from 80° C. to 220° C.

The weight-average molecular weight (Mw), as well as the number-average molecular weight (M_{N}), are determined using gel permeation chromatography (GPC).

The invention further relates to a method for reversible adhesive bonding of two substrates to one another, wherein the two substrates are adhesively bonded to one another with the molten adhesive, this adhesive layer loses its adhesive strength at a later point in time upon application of voltage, and the substrates are releasable from one another.

A composition according to the present invention must contain a polyamide. This imparts to the adhesive the properties necessary for use thereof as a hot melt adhesive, such as adhesive strength, adhesion, cohesion, melt behavior, or stability. These fundamental properties can optionally be modified using additives and added substances.

Polyamides suitable for hot melt adhesives are obtainable from organic polycarboxylic acids reacted with diamines. The constituents can be varied within broad limits; dicarboxylic acids and diamines are particularly suitable. Aliphatic or aromatic carboxylic acids can be involved, and dimer fatty acids are preferably also suitable. For utilization as a hot melt adhesive, these polyamides are intended to melt at elevated temperature, for example from 100 to 220° C. The polyamides are solid at room temperature. The carboxylic acids and the amines must be selected so that gelled and crosslinked reaction products are not obtained. Such polyamides are known in principle to one skilled in the art.

One group of suitable polyamides is those that can be manufactured on the basis of dicarboxylic acids and diamines. For example, polyamides based on dimer fatty acid-free polyamides can be selected as polyamides suitable according to the present invention. These can be manufactured from
80 to 100 mol % of one or more C4 to C24 dicarboxylic acid(s),
20 to 0 mol % of other mono-, di-, or tricarboxylic acids,
10 to 90 mol % of at least one aliphatic diamine,
10 to 80 mol % of one or more cycloaliphatic diamines,
0 to 50 mol % polyoxyalkylenediamines,
   wherein the sum of the diamines and carboxylic acids used yields 100 mol % in each case.

Another group of suitable polyamides is those that can be manufactured on the basis of dimer fatty acids and polyamines. It is possible, for example, to use polyamides constructed from the following components:
50 to 98 mol % dimer or polymer fatty acid,
2 to 50 mol % C6 to C24 aliphatic or cycloaliphatic dicarboxylic acid,
0 to 10 mol % C12 to C18 monocarboxylic acids,
   wherein the sum is to yield 100 mol %, and
100 to 60 mol % aliphatic and/or cycloaliphatic diamines,
0 to 40 mol % polyoxyalkylenediamines,
   wherein the sum is to yield 100 mol %.

“Dimer or polymer fatty acids” in terms of this invention are those fatty acids which can be obtained in known fashion by dimerization of natural raw materials. They are manufactured from unsaturated long-chain fatty acids and then purified by distillation. A “technical” dimer fatty acid in this context contains, depending on purity, less than 5% monobasic fatty acids, substantially C18 fatty acids such as linolenic acid or oleic acid, up to 98 wt % C36 dibasic fatty acids (dimer fatty acids in the strict sense), and also small proportions of higher polybasic fatty acids (“trimer fatty acids”). The relative ratios of the monomer, dimer, and trimer fatty acids in the polymer fatty acid mixture depend on the nature of the starting compounds used, and on the polymerization, dimerization, or oligomerization conditions and the degree of distillative separation. Dimer fatty acids purified by distillation contain up to 98 wt% dimer fatty acid. In a further processing step, these dimer fatty acids can also be hydrogenated. Hydrogenated dimer fatty acids of this kind can also be used according to the present invention.

As other suitable carboxylic acids or in addition to the dimer fatty acids, the acid component of the polyamide is also intended to contain C4 to C24 dicarboxylic acids. Examples of such dicarboxylic acids are succinic acid, adipic acid, azelaic acid, sebacic acid, undecanedioic acid, dodecanedioic acid, glutaric acid, suberic acid, or pimelic acid, or mixtures thereof. Portions of aromatic dicarboxylic acids, for example terephthalic acid, isophthalic acid, or mixtures of the aforesaid dicarboxylic acid, can also be used in the synthesis reaction.

It is likewise possible to add portions of long-chain aminocarboxylic acids having 10 to 18 carbon atoms, such as 11-aminoundecanoic acid, lauryl lactam, or ε-caprolactam.

The diamine component is made up substantially of one or more aliphatic diamines, wherein the amino groups are located at the ends of the carbon chains. The aliphatic diamines can contain 2 to 20 carbon atoms, wherein the aliphatic chain can be linear or branched. Examples are ethylenediamine, diethylenetriamine, dipropylenetriamine, 1,4-diaminobutane, 1,3-pentanediamine, methylpentanediamine, hexamethylenediamine, trimethylhexamethylenediamine, 2-(2-aminomethoxy)ethanol, 2-methylpentamethylenediamine, C11-neopentandiamine, diaminopropylmethylamine, or 1,12-diaminododecane. Particularly preferred primary alkylenediamines are C2 to C12 diamines having an even number of carbon atoms.

The amino component can furthermore contain cyclic diamines or heterocyclic diamines, for example 1,4-cyclohexanediamine, 4,4′-diaminodicyclohexylmethane, piperazine, cyclohexanebis(methylamine), isophoronediamine, dimethylpiperazine, dipiperidylpropane, norbornanediamine, or m-xylylenediamine. A particular embodiment uses a mixture of alkylenediamines and cyclic diamines.

If the polyamide is intended to have greater flexibility, polyoxyalkylenediamines, for example polyoxyethylenediamines, polyoxypropylenediamines, or polytetrahydrofurandiamines, can additionally be used. The polyoxyalkylenediamines in this context preferably have a molecular weight between 150 and 4000 g/mol, preferably between 300 and 3000 g/mol (number-average, M_{N}). The quantity can be in particular from 2 to 30 mol % of the amine component.

When selecting the usable monofunctional, difunctional, or trifunctional raw materials, care is to be taken that meltable, i.e. not crosslinked, products are obtained. Lower viscosity in the melt is obtained by constructing linear polyamides.

In general, the quantities of amines and carboxylic acids are selected so that equivalent quantities of amine/carboxylic acid are present; polyamides having carboxyl or amine terminal groups can be obtained. For example, the acid number can be between 1 and 20 mgKOH/g (DIN 53176). By way of the selection of short-chain diamines and the aliphatic dicarboxylic acids, and the purity of the dimer fatty acids, both the viscosity and viscosity/temperature profile, and the softening point, of the polyamide can be established so that the melt adhesive is suitable for the use according to the present invention. The molecular weight (weight-average molecular weight Mw as obtainable by GPC) can be between 10,000 and 250,000 g/mol, in particular up to 150,000 g/mol.

The corresponding polyamides are intended to have, in the melted state, a viscosity of between 1000 and 100,000 mPas (measured at 220° C., Brookfield Thermosel RVT, EN ISO 2555), preferably up to 50,000 mPas, in particular from 1000 to 10,000 mPas. The softening point of a suitable polyamide is intended to be between 100 and 220° C. (ring-and-ball per ISO 4625-1), in particular from above 140° C. to 200° C.

A preferably suitable embodiment according to the present invention uses polyamides manufactured from 50 to 75 mol % dimer fatty acids, 25 to 50 mol % aliphatic or cycloaliphatic dicarboxylic acid having 6 to 24 carbon atoms, in particular C6 to C18, and 0 to 10 mol % monocarboxylic acids, wherein the sum is to yield 100 mol %.

Another preferred embodiment uses amines as a mixture of 70 to 98 mol % of a mixture of aliphatic and cycloaliphatic diamines, in particular having 2 to 12 carbon atoms, and 2 to 30 mol % polyoxyalkylenediamines based on p-tetrahydrofuran or polypropylene glycol, wherein the sum once again is to yield 100 mol %.

Methods for manufacturing polyamides are known: the raw materials are melted and dried, and reacted with one another when hot. Reaction water that results is removed from the mixture. Once the suitable molecular weight is obtained, the polymer is filled and cooled. The polymer can be filled in the form of blocks, bars, granulates. The further additives can, however, also be added directly after polymer synthesis.

Hot melt adhesives can be manufactured from the polyamides suitable according to the present invention together with usual additives. For example, plasticizers, adhesion promoters, stabilizers, anti-foaming agents, leveling agents, or fillers can additionally be contained. Plasticizers increase the plasticity of the compositions; for example, polar plasticizers such as esters, long-chain amines, sulfonic esters are usable. Fillers can furthermore be used in subordinate quantities, for example silicates, talc, calcium carbonates, clays, carbon black, or color pastes or pigments. Electrically conductive pigment and fillers are preferably not to be used. In particular, however, the melt adhesives contain only small proportions (below 5 wt %) of pigments or fillers; in particular, they are free of fillers.

An embodiment uses polyamides in a quantity of up to 90 wt % in the hot melt adhesive. In addition, further melt adhesive polymers can be contained, for example polyurethanes, polyacrylates, or polyesters; these must be compatible with the polyamide in the melt, and must form a stable, homogeneous melt. The quantity of further polymers can be up to 30% based on the quantity of polyamide.

It is furthermore possible for the composition to contain antioxidants. Antioxidants of the sterically hindered phenol or aromatic amine derivative types are particularly suitable, in quantities of up to 2.5 wt % based on the polymer. Suitable additives are known to one skilled in the art, who can select them in accordance with the intended application and their properties.

According to the present invention it is necessary for the melt adhesive to contain at least one organic or inorganic salt. These are to be understood as salt-like compounds which can be liquid or solid at room temperature (25° C.). They can be solid salts, and also so-called “ionic liquids”. The salts can be present in a manner dissolved in the polyamide; they can be in dispersed form; they can be associated with polymer groups. Ionic or neutral compounds will be listed below, but these are to be understood in each case as the ionic structures present in the corresponding salts. It is likewise possible for corresponding salts also to contain water of crystallization in bound form.

It is possible, for example to use salts of organic acids, for example lithium, sodium, or potassium salts of aliphatic C2 to C6 mono- or dicarboxylic acids, aromatic mono- or dicarboxylic acids, trifluoromethanesulfonic acids. Another embodiment uses, as a cation of the salt, organic quaternary compounds that contain as an anion the aforesaid acids or also halides. A further preferred embodiment uses, as an anion, organic compounds that contain sulfone groups, for example trifluoromethanesulfonate, as a cyclic structure acesulfamate or saccharinate, or as a linear structure bis(trifluoromethanesulfonyl)imide or trifluoromethanecarbonyl-trifluoromethanesulfonyl imide.

A suitable organic cation is a quaternary compound, for example of the following structures: tetraalkylphosphonium, trialkylsulfonium, tetraalkylammonium, N^{T}-alkyl-substituted cyclic 5- or 6-ring amines, N⁺-alkyl-substituted aromatic 5-ring imidazolines, wherein aliphatic linear residues having 1 to 12 carbon atoms are used as an alkyl residue. The alkyl residues can be the same or different. These alkyl residues can optionally also be substituted with an OH group. In principle, the various anions and cations can be combined with one another provided the compounds exhibit salt-like properties thereafter. In a preferred embodiment the salt-like compound is intended to have a melting point above 40° C.

Examples of particularly suitable cationic groups are tetraalkyl-substituted nitrogen compounds, such as N-tetrabutylammonium, N-trimethyl-N-butylammonium, N-triethyl-N-benzylammonium, N, N-d imethylcyclohexylamine, N-methyl-N-trioctylammonium; OH-functionalized tetraalkylamines, such as trimethylhydroxyethylammonium (choline), acetylcholine, N-methyl-N-hydroxyethylcyclohexylamine; trialkyl-substituted sulfur compounds, such as triethylsulfonium, trimethylsulfonium; 5-ring nitrogen heterocycles, for example N-alkylimidazolium derivatives, such as 1-methyl-3-ethylimidazolium, 1-ethyl-3-methylimidazolium, 1-butyl-3-methylimidazolium, 1-hexadecyl-3-methylimidazolium, 1-methyl-3-octylimidazolium, 1-methyl-3-nonylimidazolium, 1-heptyl-3-methylimidazolium, 1 -ethyl-2-methylimidazolium, 1-propyl-4-methylimidazolium, 1 -propyl-2-methylimidazolium, 1,2-dimethyl-3-propylimidazolium; 6-ring nitrogen heterocycles, for example alkyl-substituted pyridinium, pyrrolidinium, piperidinium compounds, such as 1-butylpyridinium, 1 -butyl-3-methylpyridinium, 1 -butyl-4-methylpyridinium, 1-propyl-3-methylpyridinium, 1-butyl-3-propylpiperidinium, 1-butyl-1-methylpyrrolidinium, 1-butyl-3-methylpyrrolidinium, 1-hexyl-3-methylpyrrolidinium, and similar compounds.

For some applications it is preferred to use halides as anions. Tetrafluoroborate, trifluoromethanesulfonates, aromatic dicarboxylates such as phthalic acid and isomeric derivatives thereof, sulfone-group-containing compounds such as acesulfamate, saccharinate, bis(trifluoromethanesulfonyl)imide or trifluoromethanecarbonyl-trifluoromethanesulfonyl imide, are particularly suitable as an anion.

In preferred embodiments, potassium hydrogen phthalate, lithium triflate, 1-ethyl-3-methylimidazolium tetrafluoroborate, 1 -ethyl-3-methylimidazolium trifluoromethanesulfonate, 1 -ethyl-3-methylim idazolium ethyl sulfate, lithium bis(trifluoromethanesulfonimide), choline chloride, choline acesulfamate, and/or choline saccharinate are used as ionically conductive constituents.

As further constituents, which are therefore different from the polyamides, a hot melt adhesive according to the present invention can additionally contain polar compounds that promote miscibility with the salts. These are, for example, polymers such as polyphosphazenes, polymethylene sulfides, polyoxyalkylene glycols, polyethyleneimines. Low-molecular-weight polyols can also be used. These compounds can be solid or liquid at room temperature (25° C.).

One group of suitable polar compounds is low-molecular-weight di- to decavalent aliphatic polyols. These are intended to have a molecular weight of up to 1000 g/mol, preferably up to 500 g/mol (M_{N}). In particular, three to six OH groups are intended to be contained. Examples thereof are polyols such as neopentyl glycol, pentaerythritol, glycerol, sugar alcohols such as glucose, arabinose, xylose, mannitol, sorbitol, arabinose, or other compounds having multiple OH groups.

Compounds having a polyether structure are particularly suitable, in particular polyethylene glycols and polypropylene glycols having 2 to 4 OH groups or NH groups. Such polyethers are commercially obtainable. Polyether polyols having a molecular weight below 10,000 g/mol, preferably from 350 to 5000 g/mol (M_{N}), are particularly suitable. These polyethers can be solid or liquid.

The polar compounds can be used individually or as a mixture. The quantity is to be 0 to 25 wt %, in particular 5 to 20 wt %, based on the hot melt adhesive. The quantity is also based on the physical state of the compound; the adhesive is intended still to be present in solid form at room temperature.

It is known that these polar compounds are partly hygroscopic. It has been found that complete drying of the compounds is not necessary. While the suitable polyamides can also be manufactured anhydrously, they often absorb water in storage. It is possible according to the present invention for the melt adhesive to contain up to 2 wt % water.

A preferred composition for a polyamide is
75 to 30 mol % dimer fatty acid,
25 to 70 mol % C6 to C24 dicarboxylic acids,
0 to 10 mol % monocarboxylic acids,

66 to 98 mol % of at least one aliphatic diamine less than or equal to C12,
1 to 25 mol % of at least one cycloaliphatic diamine,
1 to 30 mol % polyether diamines, preferably based on polyethylene glycol or polypropylene glycol,
   wherein the sums of the diamines and carboxylic acids are each equal to 100 mol %. A slight excess of amine can be contained, so that amine-terminated polyamides occur.

A preferred adhesive composition according to the present invention is made of
70 to 30 wt % polyamide,
1 to 30 wt % inorganic or preferably organic salts,
0 to 25 wt % of at least one polar compound,
0.1 to 20 wt % additives.

A particular embodiment contains PEG or PPG having a molecular weight from 300 to 5000 g/mol as a polar compound; another preferred embodiment uses as a salt those of quaternary amino compounds and of sulfone-group-containing organic compounds.

The methods for manufacturing the melt adhesive mixtures are known to one skilled in the art. The additives can be mixed into the polyamide in melted form. If polycondensation is not prevented, the additives can also be added already in the synthesis of the polyamide. Known mixing equipment can be utilized: dissolvers, kneaders, extruders, or others. The adhesive according to the present invention can then be cooled and is then ready to store.

The hot melt adhesive according to the present invention can be applied as a hot melt adhesive. It has a softening point from 100 to 220° C. It can be melted at temperatures of, for example, up to 220° C., and is applied in the flowable state onto a substrate. The viscosity of a melt adhesive according to the present invention can be in the range from 500 to 25,000 mPas at an application temperature from 150 to 220° C. The viscosity can be adapted to the utilization method, so that it is known to lower a high viscosity by raising the temperature. Immediately thereafter the second substrate is pressed against the adhesive layer, and a physical adhesive bond has been produced after cooling. One skilled in the art is familiar with apparatuses for melting and for applying melt adhesives. The layer thickness of the adhesive layer is likewise known to one skilled in the art, who can select it in accordance with his technical knowledge. The layer thickness is usually between 5 and 1000 μm, in particular from 10 to 500 μm. After cooling, the layer that has become solid yields the adhesive bond. It can be amorphous, but it can also have crystalline constituents.

Also a subject of the invention are two substrates that are releasably connected to one another with an adhesive layer according to the present invention. The substrates can vary within broad limits. They are intended, however, to be cleaned on the surface; it is also optionally possible for additional primer layers or other coatings to be applied. Known plastics, metals, ceramic, or other substrates can be used as a substrate. The substrates can be solid and rigid; it is also possible to bond flexible substrates, for example single- or multi-layer films. It is useful according to the present invention if the substrates exhibit a conductivity. This can be achieved by way of a conductivity of the substrate itself, the substrate can have a conductive coating or, for example, electrically conductive constituents are incorporated into the substrate. The hot melt adhesives according to the present invention are particularly suitable for adhesively bonding metallic substrates or plastic substrates.

The adhesive bond produced according to the present invention can be released again by application of voltage.

It is necessary for this purpose for voltage to be applied perpendicularly to the adhesive layer, i.e. in a direction from one substrate to the other substrate. In accordance with the method according to the present invention it is necessary for the voltage to be from 9 to 100 volts, in particular from 15 to 75 volts. A DC voltage is particularly suitable. It has been found that the adhesive bond according to the present invention can be released after a necessary action time. A decrease in adhesion is observed; the two substrates can be released from one another under perpendicular tension or lateral shear. The rate of adhesion loss can be influenced by the quantity and nature of the salts. If faster separation is desired, for example 10 to 60 seconds, the quantity can be increased. If faster adhesion loss is not desired, for example 2 to 5 minutes, a smaller quantity is sufficient.

A particular embodiment of the invention additionally heats the adhesive layer. In particular, heating to up to 80° C. is useful, in particular from 40 to 70° C. Thereby, the adhesive does not become flowable; all that occurs is an adhesion loss together with the applied voltage. An adhesive adhesion loss is preferably observed. Since only a thin layer of adhesive is present, heating can be carried out quickly, thereby substantially simplifying separation of the substrates.

Heating methods are generally known to one skilled in the art. They can involve hot gases, for example hot air; radiation sources can be used; for example, IR or NIR radiation can be utilized. It is likewise possible to heat the adhesive layer using ultrasound.

The adhesives according to the present invention can adhesively bond a plurality of substrates. If electrically conductive substrates are used, the adhesive bond can be reversibly released again. The melt adhesive is applied and bonded when hot. The bonded sites can be released again as necessary, so that separation of the substrates is possible. In particular, an adhesive loss of adhesion to a substrate is observable. Inadvertent disengagement of the adhesive bond is furthermore prevented by the preferred form of a two-step mechanism.

### EXAMPLES

### Polyamide 1:

A polyamide was manufactured, using a known manufacturing method, from 100 mol % dodecanedicarboxylic acid, 50 mol % piperazine, 30 mol % Jeffamine D 400, and 20 mol % ethylenediamine, by condensation with water distilled off.

This polyamide exhibits the following values:

| Mw | 13,000 | g/mol |
|---|---|---|
| Viscosity | 9000 mPas (225° C.) | |
| Softening point | 170° | C. |

### Polyamide 2:

A polyamide was manufactured, using a known manufacturing method, from 0.1 parts by weight stearic acid, 19.3 parts by weight azelaic acid, 69.3 parts by weight dimer fatty acid, 15.1 parts by weight piperazine, and 3.6 parts by weight ethylene diamine, by condensation with water distilled off. 0.6 parts by weight stabilizers were admixed.

This polyamide exhibits the following values:

| | |
|---|---|
| Mw | 15,500 g/mol |
| Melt viscosity | 4000 mPas (225° C.). |

### Adhesive 1:

7.4 g lithium bis(trifluoromethanesulfonimide) is added to 14.6 g Jeffamine D400 and stirred at room temperature until the salt has dissolved.

78 g of Polyamide 1 is melted at 200° C., the additive was added while stirring and incorporated for approx. 8 minutes at 200° C.

The adhesive can then cool to room temperature.

### Adhesive 2:

4.7 g lithium trifluoromethanesulfonate is added to 17.3 g Jeffamine D400 and stirred at room temperature until the salt has dissolved.

78 g of Polyamide 2 is melted at 200° C., the additive was added while stirring and incorporated for approx. 8 minutes at 200° C.

The adhesive can then cool to room temperature.

### Adhesive 3:

4.3 g choline chloride is added to 17.1 g Jeffamine D400 and stirred at room temperature; a dispersion is produced.

78 g of Polyamide 2 is melted at 200° C., the additive was added while stirring and incorporated for approx. 8 minutes at 200° C.

The adhesive can then cool to room temperature and becomes solid.

Each of the three adhesives was melted at 190° C. and applied onto a cleaned and degreased aluminum test specimen, then immediately bonded to a second aluminum test specimen. The samples were left for 2 hours at room temperature.

These measurement specimens exhibit good adhesion. After application of voltage to the substrates (48 V, 5 min) the adhesive strength is reduced and the substrates can be separated from one another under tension. If the measurement specimens are heated to 65° C., the adhesive strength is likewise reduced and the substrates can likewise be separated under tension. If voltage is applied to the substrates (48 V, 5 min) and the composite is simultaneously heated to 65° C., the adhesive strength is almost completely lost. The substrates can then very easily be separated from one another with very little tension.

Shear/tension measurement (analogous to DIN 53281) (N/mm²)

| | 0 V/RT | 0 V/65° C. | 48 V/RT | 48 V/65° C. |
|---|---|---|---|---|
| Adhesive 1 | 2.8 | 0.9 | 0.4 | 0.01 |
| Adhesive 2 | 2.1 | 0.6 | 0.3 | 0.02 |
| Adhesive 3 | 1.9 | 0.2 | 1.4 | 0.01 |

What is claimed is:

1. A hot melt adhesive containing
20 to 90 wt % of at least one polyamide having a molecular weight (Mw) from 10,000 to 250,000 g/mol,
1 to 25 wt % of at least one organic or inorganic salt,
0 to 60 wt % of further additives,
wherein the adhesive has a softening point from 100° C. to 220° C. (ring-and-ball method, ISO 4625-1).

2. The hot melt adhesive according to claim 1, characterized in that it contains 5 to 25 wt % of a compound comprising polar groups, selected from polyethers, polymethylene sulfides, polyphosphazenes, polyethyleneimines, or polyols having two to ten OH groups.

3. The hot melt adhesive according to claim 2, characterized in that the compound comprising polar groups is selected from i) polyethers comprising two or three OH or NH₂ groups and having a molecular weight from 350 to 10,000 g/mol, and/or ii) divalent to hexavalent polyols having a molecular weight below 1000 g/mol.

4. The hot melt adhesive according to claim 1, characterized in that the salt contains a cation selected from K, Na, Li, tetraalkylphosphonium, trialkylsulfonium, tetraalkylammonium, N⁺-alkyl-substituted cyclic five- or six-ring amines, N⁺-alkyl-substituted aromatic five-ring imidazolines, wherein aliphatic linear groups having 1 to 12 carbon atoms are contained as an alkyl group.

5. The hot melt adhesive according to claim 4, characterized in that the salt contains an anion selected from i) organic acids as aliphatic C2 to C6 mono- or dicarboxylic acids, aromatic mono- or dicarboxylic acids, trifluoromethanesulfonic acid, or from ii) organic sulfonamides as acesulfamate, saccharinate, bis(trifluoromethanesulfonyl)imide, or trifluoromethanecarbonyl-trifluoromethanesulfonyl imide.

6. The hot melt adhesive according to claim 4, characterized in that the molecular weight of the salt is less than 1000 g/mol.

7. The hot melt adhesive according to claim 6, characterized in that the salt is liquid at 25° C.

8. The hot melt adhesive according to claim 1, characterized in that the polyamide contains at least 50 mol % dimer fatty acid, based on the acid component.

9. The hot melt adhesive according to claim 1, characterized in that the polyamide contains at least 1 to 30 mol % polyether amines, based on the amine component.

10. The hot melt adhesive according to claim 1, characterized in that the adhesive as a layer decreases its adhesive strength under the action of voltage.

11. A method for releasing a hot melt adhesive bond, characterized in that a layer of a hot melt adhesive according to claim 1 is exposed to a voltage between 9 and 80 V.

12. The method according to claim 11, characterized in that the layer is additionally heated, preferably below 80° C.

13. The method according to claim 11, characterized in that the layer has a thickness from 5 μm to 1 mm.

14. A composite of two substrates and an adhesive layer located therebetween, wherein the adhesive layer is made of a hot melt adhesive according to claim 1.

15. The composite according to claim 14, characterized in that solid or flexible substrates are bonded as substrates, wherein the substrates or the surfaces thereof are electrically conductive.
